(19) United States
(12) Patent Application Publication
(10) Pub. No.: US 2014/0059097 A1
(43) Pub. Date: Feb. 27, 2014

(54) MULTIPLYING DEVICE AND MULTIPLYING METHOD

(71) Applicant: FUJITSU LIMITED, Kawasaki-shi (JP)

(72) Inventor: Kenichi KITAMURA, Kawasaki (JP)

(21) Appl. No.: 13/924,661

(22) Filed: Jun. 24, 2013

(30) Foreign Application Priority Data
Aug. 22, 2012 (JP) 2012-183419

(51) Int. Cl. G06F 5/01; G06F 7/485; G06F 7/487

(52) U.S. Cl. CPC G06F 5/012; G06F 7/4876; G06F 7/485
USPC 708/209

(57) ABSTRACT

A multiplying device includes: a circuit which left-shifts a mantissa part of a floating-point number being a multiplicand by a shift amount; a circuit which calculates a digit number of the mantissa part of the multiplier by subtracting the count value from the digit number of the fixed precision of the mantissa part; a multiplying circuit which outputs an intermediate product on a digit-by-digit basis of the mantissa part of the multiplier based on the mantissa part of the left-shifted multiplicand and the mantissa part of the multiplier; an adding circuit which adds exponent parts of the multiplicand and the multiplier; and a control circuit which outputs the intermediate product output by the multiplying circuit, as a mantissa part of a floating-point number being a product and outputs the value output by the adding circuit, as an exponent part of the floating-point number being the product.

### CROSS-REFERENCE TO RELATED APPLICATION

This application is based upon and claims the benefit of priority of the prior Japanese Patent Application No. 2012-183419, filed on Aug. 22, 2012, the entire contents of which are incorporated herein by reference.

### FIELD

The embodiments discussed herein are directed to a multiplying device and a multiplying method.

### BACKGROUND

There has been known a floating-point multiplying device having a multiplying circuit for multiplying mantissa parts of normalized floating-point numbers (for example, refer to Patent Document 1). A first zero detecting circuit detects the number of zeros consecutive in a highest place side of a fixed point number being a multiplicand. A second zero detecting circuit detects the number of zeros consecutive in a highest place side of a fixed-point number being a multiplier. A first left-shifting circuit left-shifts the multiplicand by the number of the zeros detected by the first zero detecting circuit to supply the resultant to the multiplying circuit. A second left-shifting circuit left-shifts the multiplier by the number of the zeros detected by the second zero detecting circuit to supply the resultant to the multiplying circuit. An adder adds the numbers of the zeros detected by the first and second zero detecting circuits. A right-shifting circuit right-shifts a result of multiplication that the multiplying circuit performs on the multiplicand and the multiplier which are left-shifted by the first and second left-shifting circuits, by a number indicated by a result of the addition of the adder.
[Patent Document 1] Japanese Laid-open Patent Publication No. 05-40605

In Patent Document 1, the right-shifting circuit requires a digit width twice as high as format precision at the maximum, which increases both a resource amount and a delay time.

### SUMMARY

A multiplying device includes: a counting circuit which counts the number of zeros consecutive in higher places of a mantissa part of a floating-point number being a multiplier; a shift amount arithmetic circuit which calculates a shift amount based on a digit number of fixed precision of the mantissa part and a count value counted by the counting circuit; a shifting circuit which left-shifts a mantissa part of a floating-point number being a multiplicand by the shift amount; a digit number arithmetic circuit which calculates a digit number of the mantissa part of the multiplier by subtracting the count value from the digit number of the fixed precision of the mantissa part; a multiplying circuit which outputs an intermediate product on a digit-by-digit basis of the mantissa part of the multiplier based on the mantissa part of the multiplicand left-shifted by the shifting circuit and the mantissa part of the multiplier; an adding circuit which adds an exponent part of the floating-point number being the multiplicand and an exponent part of the floating-point number being the multiplier to output an addition value; and a control circuit which outputs the intermediate product output by the multiplying circuit as a mantissa part of a floating-point number being a product and outputs the value output by the adding circuit as an exponent part of the floating-point number being the product, when the number of times the multiplying circuit outputs the intermediate product is the digit number calculated by the digit number arithmetic circuit.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory chart of a multiplying method of fixed-point numbers.

FIG. 2 is an explanatory chart of a multiplying method of denormalized floating-point numbers.

FIG. 3 is an explanatory chart of a multiplying method of denormalized fixed-precision floating-point numbers.

FIG. 4 is an explanatory chart of a first multiplying method according to a first embodiment.

FIG. 5 is an explanatory chart of a second multiplying method according to the first embodiment.

FIG. 6 is an explanatory chart of a third multiplying method according to the first embodiment.

FIG. 7 is an explanatory chart of a fourth multiplying method according to the first embodiment.

FIG. 8 is an explanatory chart of a fifth multiplying method according to the first embodiment.

FIG. 9 is a diagram depicting a structure example of a multiplying device according to the first embodiment.

FIG. 10 is a diagram depicting a structure example of a multiplication loop circuit in FIG. 9.

FIG. 11 is a chart representing a correspondence relation of an input and an output of a product generation and select circuit in FIG. 10.

FIG. 12A to FIG. 12D are charts representing a control method of a control circuit in FIG. 9.

FIG. 13 is a diagram depicting a structure example of a multiplying device according to a second embodiment.

FIG. 14A to FIG. 14D are charts representing a control method of a control circuit in FIG. 13.

### DESCRIPTION OF EMBODIMENTS

### First Embodiment

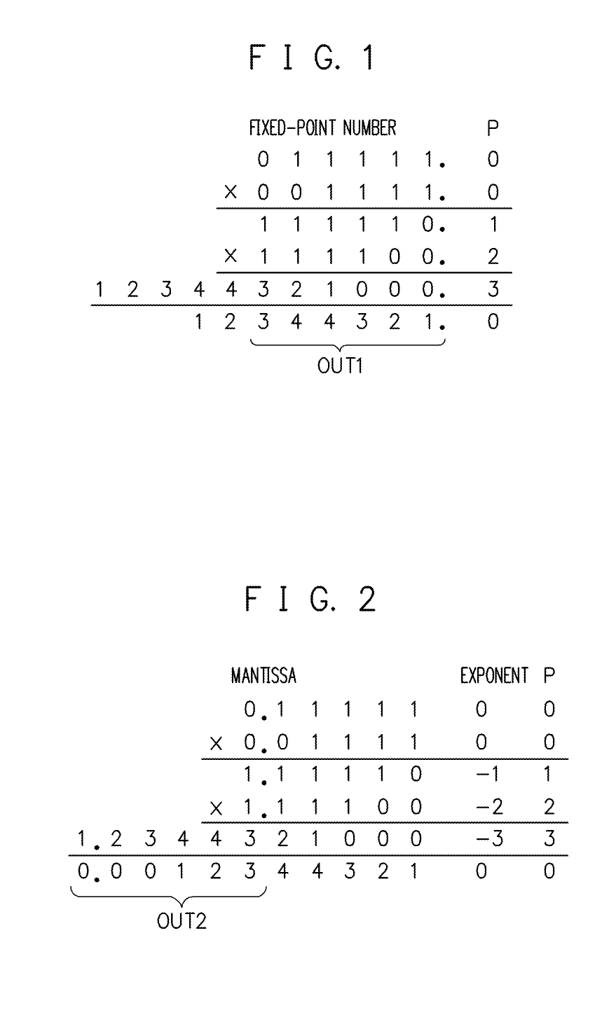

FIG. 1 is an explanatory chart of a multiplying method of fixed-point numbers. “011111” is a fixed-point decimal number being a multiplicand. “001111” is a fixed-point decimal number being a multiplier. A multiplicand reading zero count value P1 is the number of zeros consecutive in higher places of the multiplicand “011111” and is “1”. A multiplier reading zero count value P2 is the number of zeros consecutive in higher places of the multiplier “001111” and is “2”. “111110” is a normalized number resulting from left-shift of the multiplicand “011111” by “1” being the multiplicand reading zero count value P1. “111100” is a normalized number resulting from left-shift of the multiplier “001111” by “2” being the multiplier reading zero count value P2. “12344321000” is a product of multiplication of the normalized number “111110” of the multiplicand by the normalized number “111100” of the multiplier. “3” being a value P on the right thereof is expressed by P1+P2=1+2=3. A product “12344321” is a value resulting from right-shift of the product “12344321000” by “3” being the value P. A right-shifting circuit for performing this right-shift requires 6×2=12 digits at the maximum when a digit number of fixed precision of the multiplicand and the multiplier is “6”, which increases a resource amount. An output OUT1 of the product is a fixed-point number which is “344321” whose fixed precision is six digits, and an accurate value cannot be obtained.

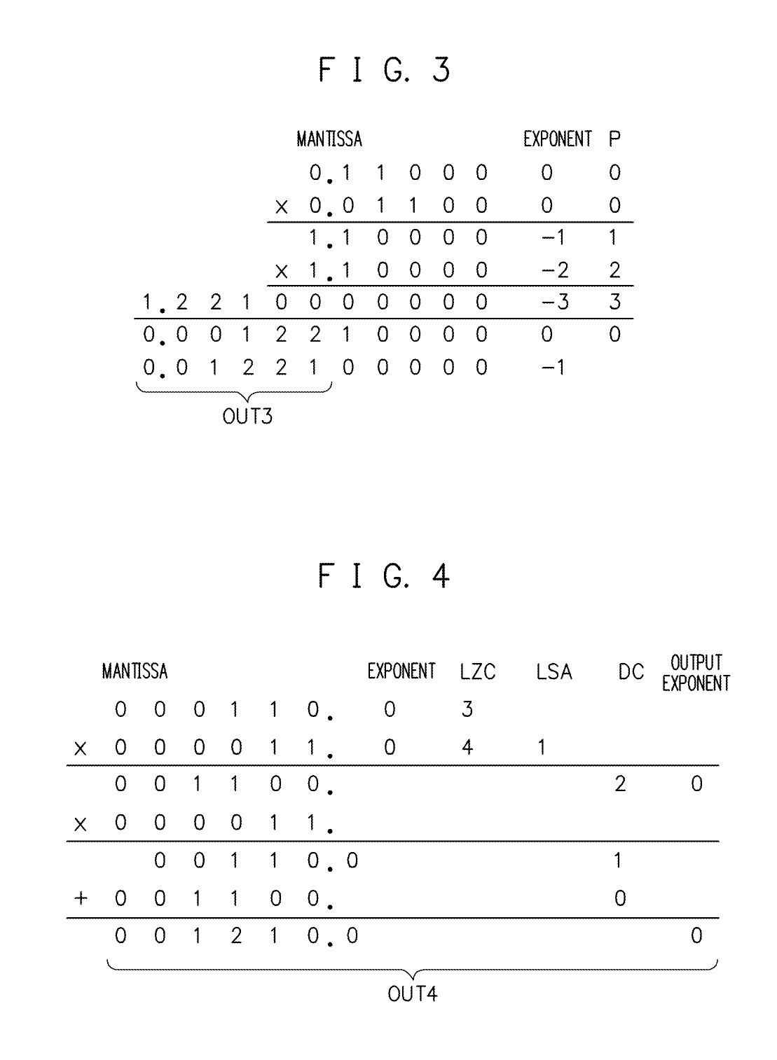

FIG. 2 is an explanatory chart of a multiplying method of denormalized floating-point numbers. The floating-point numbers each have a mantissa part sf and an exponent part exp and are expressed by sf×10^{exp} in the case of a decimal number. A multiplicand has a mantissa part “0.11111” and an exponent part “0”. A multiplier has a mantissa part “0.01111” and an exponent part “0”. A multiplicand reading zero count value P1 is the number of zeros consecutive in higher places of the mantissa part “0.11111” of the multiplicand and is “1”. A multiplier reading zero count value P2 is the number of zeros consecutive in higher places of the multiplier “0.01111” and is “2”. “1.11110”” being a normalized mantissa part of the multiplicand is a normalized number resulting from left-shift of the mantissa part “0.11111” of the multiplicand by “1” being the multiplicand reading zero count value P1. “1.11100” being a normalized mantissa part of the multiplier is a normalized number resulting from left-shift of the mantissa part “0.01111” of the multiplier by “2” being the multiplier reading zero count value P2. “−1” being a normalized exponent part of the multiplicand results from subtraction of “1” being the multiplicand reading zero count value P1 from the exponent part “0” of the multiplicand and is expressed by 0−1=−1. “−2” being a normalized exponent part of the multiplier results from subtraction of “2” being the multiplier reading zero count value P2 from the exponent part “0” of the multiplier and is expressed by 0−2=−2. “1.2344321000” being a mantissa part of a product is a product of multiplication of the normalized mantissa part “1.11110” of the multiplicand by the normalized mantissa part “1.11100” of the multiplier. “−3” being an exponent part of the product results from addition of the normalized exponent part “−1” of the multiplicand and the normalized exponent part “−2” of the multiplier and is expressed by (−1)+(−2)=−3. “3” being a value P on the right thereof is expressed by P1+P2=1+2=3. “0.0012344321” being a mantissa part of a product is a value resulting from right-shift of the mantissa part “1.2344321000” of the product by “3” being the value P. “0” being an exponent part on the right thereof results from addition of “−3” being the exponent part thereabove and “3” being the value P and is expressed by −3+3=0. Since fixed precision of the mantissa part of the product is six digits, an output OUT2 which is “0.00123” being the six most significant digits among the mantissa part “0.0012344321” of the product is output as the mantissa part of the product. The output OUT2 of the product has a mantissa part “0.00123” and an exponent part “0”. However, precision of the mantissa part of the output OUT2 of the product worsens due to a reduction of the effective digit number to three digits. Here, a multiplying method represented in FIG. 3 can be thought.

FIG. 3 is an explanatory chart of a multiplying method of denormalized fixed-precision floating-point numbers in a format in which it is defined that when shifting an arithmetic result makes it possible to output an accurate result, the result obtained by the shift of the arithmetic result should be output, such as a decimal floating-point format of IEEE754-2008. A multiplicand has a mantissa part “0.11000” and an exponent part “0”. A multiplier has a mantissa part “0.01100” and an exponent part “0”. A multiplicand reading zero count value P1 is the number of zeros consecutive in higher places of the mantissa part “0.11000” of the multiplicand and is “1”. A multiplier reading zero count value P2 is the number of zeros consecutive in higher places of the mantissa part “0.01100” of the multiplier and is “2”. “1.10000” being a normalized mantissa part of the multiplicand is a normalized number resulting from left-shift of the mantissa part “0.11000” of the multiplicand by “1” being the multiplicand reading zero count value P1. “1.10000” being a normalized mantissa part of the multiplier is a normalized number resulting from left-shift of the mantissa part “0.01100” of the multiplier by “2” being the multiplier reading zero count value P2. “−1” being a normalized exponent part of the multiplicand results from subtraction of “1” being the multiplicand reading zero count value P2 from the exponent part “0” of the multiplicand and is expressed by 0−1=−1. “−2” being a normalized exponent part of the multiplier results from subtraction of “2” being the multiplier reading zero count value P2 from the exponent part “0” of the multiplier and is expressed by 0−2=−2. “1.2210000000” being a mantissa part of a product is a product of multiplication of the normalized mantissa part “1.10000” of the multiplicand by the normalized mantissa part “1.10000” of the multiplier. “−3” being an exponent part of the product results from addition of the normalized exponent part “−1” of the multiplicand and the normalized exponent part “−2” of the multiplier and is expressed by (−1)+(−2)=−3. “3” being a value P on the right thereof is expressed by P1+P2=1+2=3. “0.0012210000” being a mantissa part of a product is a value resulting from right-shift of the mantissa part “1.2210000000” of the product by “3” being the value P. “0” being an exponent part on the right thereof results from addition of “−3” being the exponent part thereabove and “3” being the value P and is expressed by −3+3=0. Fixed precision of the mantissa part of the product is six digits, and therefore, when an attempt is made to set “0.00122” being the six most significant digits of the mantissa part “0.0012210000” of the product, as a mantissa part of the product, digit cancelation occurs, leading to worsened precision. Therefore, the mantissa part “0.0012210000” of the product is left-shifted by one digit by a left-shifting circuit, “1” is subtracted from the exponent part “0” of the product so that the exponent part becomes “−1”, and an output OUT3 of a product is output. The output OUT3 of the product has a mantissa part “0.01221” and an exponent part “−1”. This makes it possible to prevent the digit cancelation and improve precision. However, there is a problem of an increase of a resource amount and a delay time due to the need to add the left-shifting circuit.

FIG. 4 is an explanatory chart of a first multiplying method according to a first embodiment. In the first multiplying method, denormalized fixed-precision floating-point numbers are multiplied. A digit number m of fixed precision of mantissa parts of a multiplicand, a multiplier, and a product is, for example, six digits. The multiplicand has a mantissa part “000110” and an exponent part “0”. The multiplier has a mantissa part “000011” and an exponent part “0”. A multiplicand reading zero count value LZC1 is the number of zeros consecutive in higher places of the mantissa part “000110” of the multiplicand and is “3”. A multiplier reading zero count value LZC2 is the number of zeros consecutive in higher places of the mantissa part “000011” of the multiplier and is “4”. “1” being a shift amount LSA is expressed by m−LZC2−1=6−4−1=1. The shift amount LSA corresponds to the last shift amount of the left-shifting circuit in FIG. 3.

“001100” being a mantissa part of a shifted multiplicand is a number resulting from left-shift of the mantissa part “000110” of the multiplicand by “1” being the shift amount LSA. A digit number DC of the mantissa part of the multiplier is expressed by m−LZC2=6−4=2. “0” being an exponent part of a product is a value resulting from addition of the exponent part “0” of the multiplicand and the exponent part “0” of the multiplier.

Next, the mantissa part “001100” of the shifted multiplicand is multiplied by the least significant digit “1” of the mantissa part “000011” of the multiplier and the resultant is right-shifted by one digit, whereby a partial product “00110.0” of the mantissa parts is obtained. The digit number DC of the mantissa part of the multiplier is decremented to “1” from “2”.

Next, the mantissa part “001100” of the shifted multiplicand is multiplied by the second least significant digit “1” of the mantissa part “000011” of the multiplier, whereby a partial product “001100” of the mantissa parts is obtained. The digit number DC of the mantissa part of the multiplier is decremented to “0” from “1”.

When the digit number DC of the mantissa part of the multiplier becomes “0”, the partial product “00110.0” relevant to the least significant digit and the partial product “001100” relevant to the second least significant digit are added, so that an intermediate product “001210.0” is obtained. An exponent part of the product is left “0”.

Next, “001210” whose fixed precision is six digits out of the intermediate product “001210.0” is output as an output OUT4 of the product. The output OUT4 of the product has a mantissa part “001210” and an exponent part “0”. Consequently, a highly precise product free of digit cancellation is obtained. Further, since a shifting circuit or a register with m×2=6×2=12 digits as in FIG. 3 is not necessary, it is possible to reduce a resource amount and a delay time.

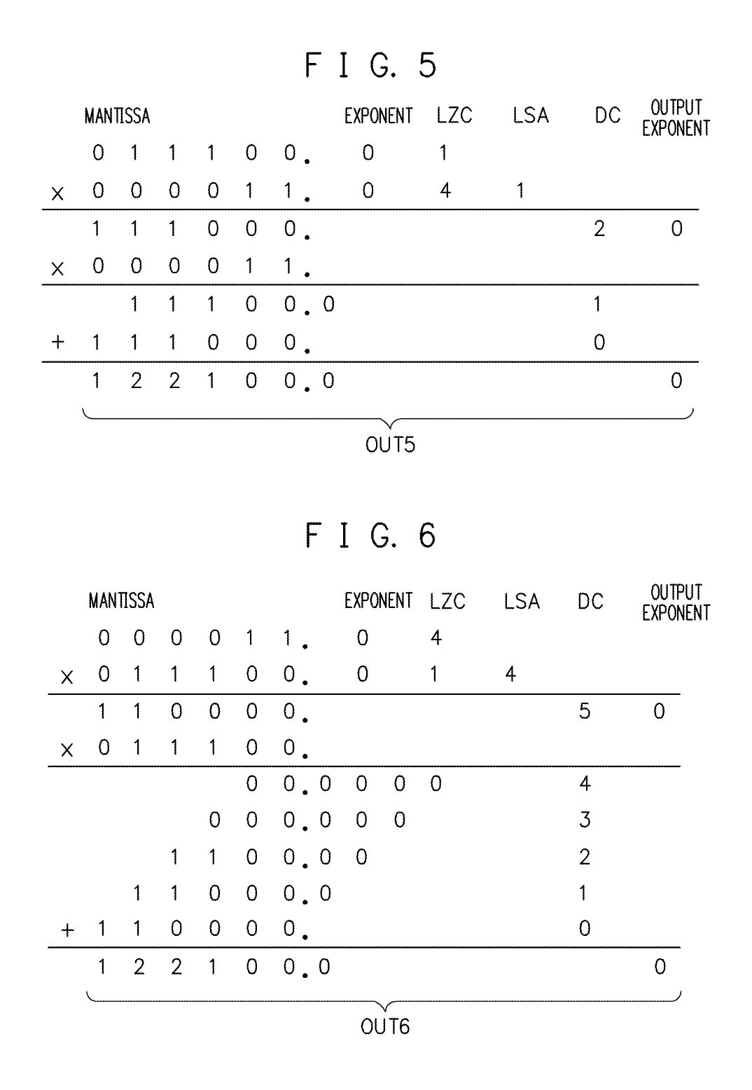

FIG. 5 is an explanatory chart of a second multiplying method according to the first embodiment. In the second multiplying method, denormalized fixed-precision floating-point numbers are multiplied. In the first multiplying method in FIG. 4, the case where the most significant digit of the mantissa part of the output OUT4 of the final product is 0 is presented, but in the second multiplying method in FIG. 5, a case where the most significant digit of a mantissa part of an output OUT5 of a final product is any one of 1 to 9 is presented. A multiplicand has a mantissa part “011100” and an exponent part “0”. A multiplier has a mantissa part “000011” and an exponent part “0”. A multiplicand reading zero count value LZC1 is the number of zeros consecutive in higher places of the mantissa part “011100” of the multiplicand and is “1”. A multiplier reading zero count value LZC2 is the number of zeros consecutive in higher places of the mantissa part “000011” of the multiplier and is “4”. “1” being a shift amount LSA is expressed by m−LZC2−1=6−4−1=1.

“111000” being a mantissa part of a shifted multiplicand is a number resulting from left-shift of the mantissa part “011100” of the multiplicand by “1” being the shift amount LSA. A digit number DC of the mantissa part of the multiplier is expressed by m−LZC2=6−4=2. “0” being an exponent part of a product is a value resulting from addition of the exponent part “0” of the multiplicand and the exponent part “0” of the multiplier.

Next, the mantissa part “111000” of the shifted multiplicand is multiplied by the least significant digit “1” of the mantissa part “000011” of the multiplier and the resultant is right-shifted by one digit, whereby a partial product “11100.0” of the mantissa parts is obtained. The digit number DC of the mantissa part of the multiplier is decremented to “1” from “2”.

Next, the mantissa part “111000” of the shifted multiplicand is multiplied by the second least significant digit “1” of the mantissa part “000011” of the multiplier, whereby a partial product “111000” of the mantissa parts is obtained. The digit number DC of the mantissa part of the multiplier is decremented to “0” from “1”.

When the digit number DC of the mantissa part of the multiplier becomes “0”, the partial product “11100.0” relevant to the least significant digit and the partial product “111000” relevant to the second least significant digit are added, and an intermediate product “122100.0” is obtained. An exponent part of the product is left “0”.

Next, “122100” whose fixed precision is six digits out of the intermediate product “122100.0” is output as the output OUT5 of the product. The output OUT5 of the product has a mantissa part “122100” and an exponent part “0”. Consequently, a highly precise product free of digit cancelation can be obtained.

FIG. 6 is an explanatory chart of a third multiplying method according to the first embodiment. In the third multiplying method, there is presented a method of multiplying denormalized fixed-precision floating-point numbers when a digit number of a mantissa part of a multiplier is larger than a digit number of a mantissa part of a multiplicand. The multiplicand has the mantissa part “000011” and an exponent part “0”. The multiplier has the mantissa part “011100” and an exponent part “0”. A multiplicand reading zero count value LZC1 is the number of zeros consecutive in higher places of the mantissa part “000011” of the multiplicand and is “4”. A multiplier reading zero count value LZC2 is the number of zeros consecutive in higher places of the mantissa part “011100” of the multiplier and is “1”. “1” being a shift amount LSA is expressed by m−LZC2−1=6−1−1=4.

A mantissa part “110000” of a shifted multiplicand is a number resulting from left-shift of the mantissa part “000011” of the multiplicand by “4” being the shift amount LSA. A digit number DC of the mantissa part of the multiplier is expressed by m−LZC2=6−1=5. “0” being an exponent part of a product is a value resulting from addition of the exponent part “0” of the multiplicand and the exponent part “0” of the multiplier.

Next, the mantissa part “110000” of the shifted multiplicand is multiplied by the least significant digit “0” of the mantissa part “011100” of the multiplier and the resultant is right-shifted by four digits, whereby a partial product “00.0000” of the mantissa parts is obtained. The digit number DC of the mantissa part of the multiplier is decremented to “4” from “5”.

Next, the mantissa part “110000” of the shifted multiplicand is multiplied by the second least significant digit “0” of the mantissa part “011100” of the multiplier and the resultant is right-shifted by three digits, whereby a partial product “000.000” of the mantissa parts is obtained. The digit number DC of the mantissa part of the multiplier is decremented to “3” from “4”.

Next, the mantissa part “110000” of the shifted multiplicand is multiplied by the third least significant digit “1” of the mantissa part “011100” of the multiplier and the resultant is right-shifted by two digits, whereby a partial product “1100.00” of the mantissa parts is obtained. The digit number DC of the mantissa part of the multiplier is decremented to “2” from “3”.

Next, the mantissa part “110000” of the shifted multiplicand is multiplied by the fourth least significant digit “1” of the mantissa part “011100” of the multiplier and the resultant is right-shifted by one digit, whereby a partial product “11000.0” of the mantissa parts is obtained. The digit number DC of the mantissa part of the multiplier is decremented to “1” from “2”.

Next, the mantissa part “110000” of the shifted multiplicand is multiplied by the fifth least significant digit “1” of the mantissa part “011100” of the multiplier, whereby a partial product “110000” of the mantissa parts is obtained. The digit number DC of the mantissa part of the multiplier is decremented to “0” from “1”.

Next, when the digit number DC of the mantissa part of the multiplier becomes “0”, the aforesaid five partial products relevant to the first to fifth least significant digits are added, whereby an intermediate product “122100.0” is obtained. An exponent part of the product is left “0”.

Next, “122100” whose fixed precision is six digits out of the intermediate product “122100.0” is output as an output OUT6 of the product. The output OUT6 of the product has a mantissa part “122100” and an exponent part “0”. Consequently, a highly precise product free of digit cancelation can be obtained.

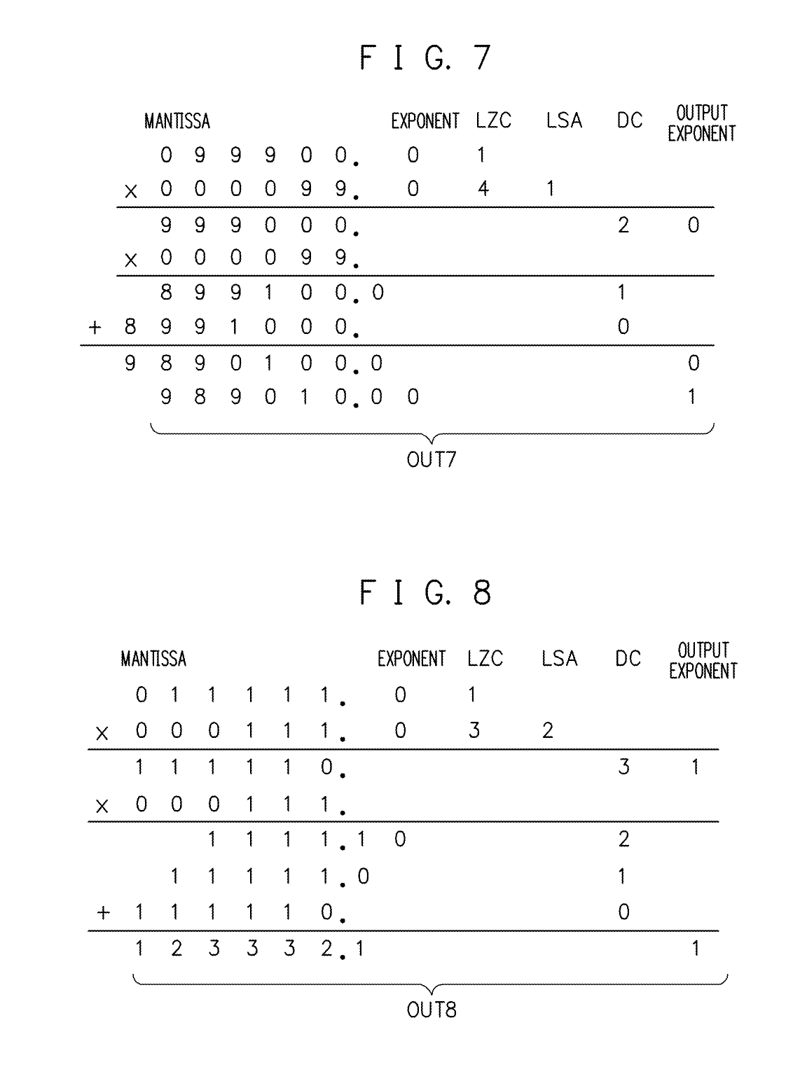

FIG. 7 is an explanatory chart of a fourth multiplying method according to the first embodiment. In the fourth multiplying method, there is presented a method of multiplying denormalized fixed-precision floating-point numbers when an overflow occurs in an intermediate product. A multiplicand has a mantissa part “099900” and an exponent part “0”. A multiplier has a mantissa part “000099” and an exponent part “0”. A multiplicand reading zero count value LZC1 is the number of zeros consecutive in higher places of the mantissa part “099900” of the multiplicand and is “1”. A multiplier reading zero count value LZC2 is the number of zeros consecutive in higher places of the mantissa part “000099” of the multiplier and is “4”. “1” being a shift amount LSA is expressed by m−LZC2−1=6−4−1=1.

A mantissa part “999000” of a shifted multiplicand is a number resulting from left-shift of the mantissa part “099900” of the multiplicand by “1” being the shift amount LSA. A digit number DC of the mantissa part of the multiplier is expressed by m−LZC2=6−4=2. “0” being an exponent part of a product is a value resulting from addition of the exponent part “0” of the multiplicand and the exponent part “0” of the multiplier.

Next, the mantissa part “999000” of the shifted multiplicand is multiplied by the least significant digit “9” of the mantissa part “000099” of the multiplier and the resultant is right-shifted by one digit, whereby a partial product “899100.0” of the mantissa parts is obtained. The digit number DC of the mantissa part of the multiplier is decremented to “1” from “2”.

Next, the mantissa part “999000” of the shifted multiplicand is multiplied by the second least significant digit “9” of the mantissa part “000099” of the multiplier, whereby a partial product “8991000” of the mantissa parts is obtained. The digit number DC of the mantissa part of the multiplier is decremented to “0” from “1”.

Next, when the digit number DC of the mantissa part of the multiplier becomes “0”, the partial product “899100.0” relevant to the least significant digit and the partial product “8991000” relevant to the second least significant digit are added, whereby an intermediate product “9890100.0” is obtained. An exponent part of the product is left “0”. Here, an integer part of the intermediate product “9890100.0” has seven digits, which exceeds a digit number m of fixed precision=6, and this is a state of the overflow.

Next, since the seventh least significant digit of the integer part of the intermediate product “9890100.0” is one of “1 to 9”, it is determined that this is an overflow state. In this case, the intermediate product “9890100.0” is right-shifted by one digit to increment the exponent part of the product from “0” to “1”, and an output OUT7 of the product is output. The output OUT7 of the product has a mantissa part “989010” and an exponent part “1”. Consequently, the overflow is prevented and a highly precise product is obtained.

FIG. 8 is an explanatory chart of a fifth multiplying method according to the first embodiment. In the fifth multiplying method, there is presented a method of multiplying denormalized fixed-precision floating-point numbers when a shift amount LSA is larger than a multiplicand reading zero count value LZC1. A multiplicand has a mantissa part “011111” and an exponent part exp1 being “0”. A multiplier has a mantissa part “000111” and an exponent part exp2 being “0”. The multiplicand reading zero count value LZC1 is the number of zeros consecutive in higher places of the mantissa part “011111” of the multiplicand and is “1”. A multiplier reading zero count value LZC2 is the number of zeros consecutive in higher places of the mantissa part “000111” of the multiplier and is “3”. “2” being the shift amount LSA is expressed by m−LZC2−1=6−3−1=2.

Here, since “2” being the shift amount LSA is larger than “1” being the multiplicand reading zero count value LZC1, it is not possible to left-shift the mantissa part “011111” of the multiplicand by “2” being the shift amount LSA. In this case, the mantissa part “011111” of the multiplicand is left-shifted by “1” being the multiplicand reading zero count value LZC1, whereby a mantissa part “111110” of a shifted multiplicand is obtained. A digit number DC of the mantissa part of the multiplier is expressed by m−LZC2=6−3=3. “1” being an exponent part of a product is expressed by exp1+exp2+LSA−LZC1=0+0+2−1=1 as a result of the correction.

Next, the mantissa part “111110” of the shifted multiplicand is multiplied by the least significant digit “1” of the mantissa part “000111” of the multiplier and the resultant is right-shifted by two digits, whereby a partial product “1111.10” of the mantissa parts is obtained. The digit number DC of the mantissa part of the multiplier is decremented to “2” from “3”.

Next, the mantissa part “111110” of the shifted multiplicand is multiplied by the second least significant digit “1” of the mantissa part “000111” of the multiplier and the resultant is right-shifted by one digit, whereby a partial product “11111.0” of the mantissa parts is obtained. The digit number DC of the mantissa part of the multiplier is decremented to “1” from “2”.

Next, the mantissa part “111110” of the shifted multiplicand is multiplied by the third least significant digit “1” of the mantissa part “000111” of the multiplier, whereby a partial product “111110” of the mantissa parts is obtained. The digit number DC of the mantissa part of the multiplier is decremented to “0” from “1”.

Next, when the digit number DC of the mantissa part of the multiplier becomes “0”, the aforesaid partial products relevant to the first to third least significant digits are added, whereby an intermediate product “123332.1” is obtained. An exponent part of the product is left “1”. In this state, an output OUT8 of the product is output. The output OUT8 of the product has a mantissa part, which has an integer part “123332” and a fractional part “0.1”, and an exponent part “1”. Thereafter, in the mantissa part of the product, for example, the fractional part is rounded off, and the mantissa part “123332” and the exponent part “1” are output. As described above, by correcting the left-shift amount and the exponent part, a highly precise product is obtained.

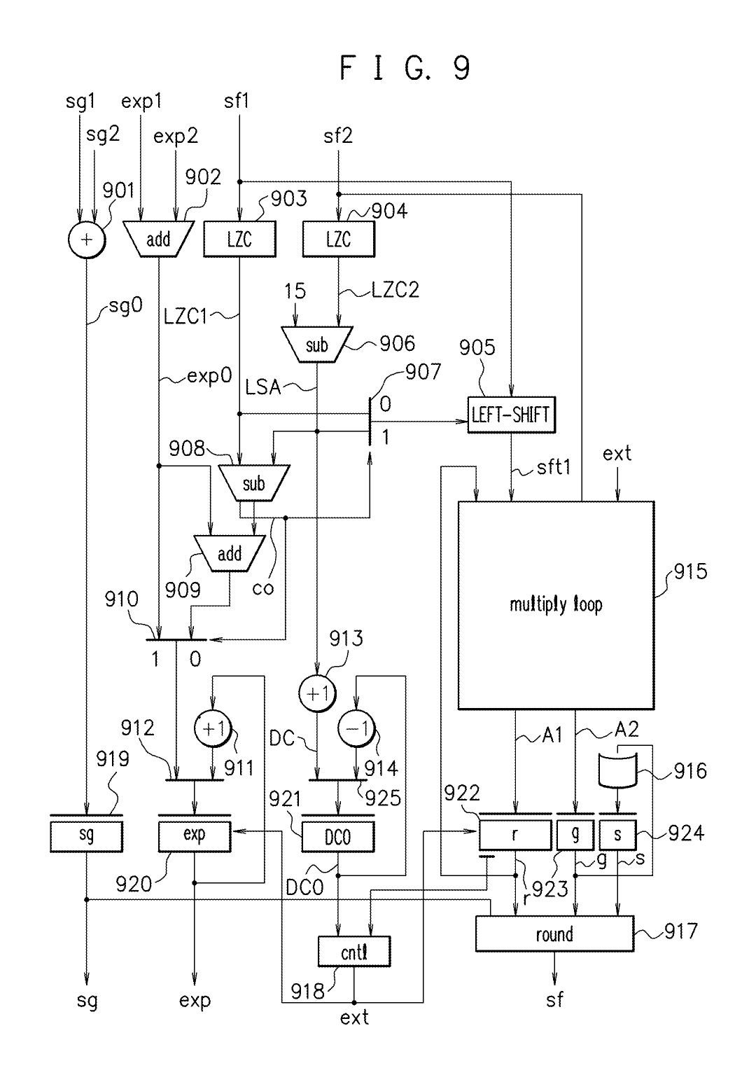

FIG. 9 is a diagram depicting a structure example of a multiplying device according to the first embodiment. This multiplying device is capable of performing the above-described multiplications in FIG. 4 to FIG. 8. A floating-point number being a multiplicand has a positive-negative sign sg1, a mantissa part sf1, and an exponent part exp1, and is expressed by (−1)^{sg1}×sf1×10^{exp1} in the case of a decimal number. A floating-point number being a multiplier has a positive-negative sign sg2, a mantissa part sf2, and an exponent part exp2 and is expressed by (−1)^{sg2}×sf2×10^{exp2} in the case of a decimal number. The positive-negative signs sg1 and sg2 represent positive when they are “0” and represent negative when they are “1”.

An exclusive logical sum circuit 901 is a positive-negative sign arithmetic circuit and outputs an exclusive logical sum value of the positive-negative sign sg1 of the multiplicand and the positive-negative sign sg2 of the multiplier as a positive-negative sign sg0. That is, the exclusive logical sum circuit 901 receives the positive-negative sign sg1 of the floating-point number being the multiplicand and the positive-negative sign sg2 of the floating-point number being the multiplier, and when the both positive-negative signs are the same, it outputs the positive-negative sign sg0 of a floating-point number being a product as positive (value “0”), and when the both positive-negative signs are different, it outputs the positive-negative sign sg0 of the floating-point number being the product as negative (value “1”). A register 919 holds the positive-negative sign sg0 and outputs the positive-negative sign sg0 as a positive-negative sign sg of the floating-point number being the product.

An adding circuit 902 adds the exponent part exp1 of the floating-point number being the multiplicand and the exponent part exp2 of the floating-point number being the multiplier to output a resultant value exp0 (=exp1+exp2).

A multiplicand reading zero count circuit 903 counts, as the multiplicand reading zero count value LZC1, the number of zeros consecutive in higher places of the mantissa part sf1 of the floating-point number being the multiplicand. A multiplier reading zero count circuit 904 counts, as the multiplier reading zero count value LZC2, the number of zeros consecutive in higher places of the mantissa part sf2 of the floating-point number being the multiplier.

A subtracting circuit 906 is a shift amount arithmetic circuit and it calculates “15”−LZC2 to output the shift amount LSA. Concretely, the subtracting circuit 906 subtracts the multiplier reading zero count value LZC2 and 1 from a digit number m of fixed precision of the mantissa parts sf1 and sf2 to calculate the shift amount LSA as in the following expression. Here, m is, for example, 16.

$$\begin{matrix}LSA = m - LZC 2 - 1 \\ = 16 - LZC 2 - 1 \\ = 15 - LZC 2\end{matrix}$$

A subtracting circuit 908 subtracts the multiplicand reading zero count value LZC1 from the shift amount LSA to output LSA−LZC1 and also outputs a carry-out co. The carry-out co is “1” when LSA−LZC1 is zero or more, and is “0” when LSA−LZC1 is a negative value.

An adding circuit 909 adds the output value “LSA−LZC1” of the subtracting circuit 908 and the value exp0 to output exp0+LSA−LZC1. A selector 910 selects and outputs the value exp0 when the carry-out co is “1”, and selects and outputs the value exp0+LSA−LZC1 when the carry-out co is “0” (for example, the case of FIG. 8).

An incrementing circuit 911 increments the output value exp of a register 920 to output the value exp+1. A selector 912 selects and outputs the output value of the selector 910 at the time of the first multiplication for an intermediate product, and selects and outputs the output value of the incrementing circuit 911 at the time of the multiplication for the intermediate product from the second time onward. The value of the register 920 is updated to the output value of the selector 912 according to a correction signal ext or the like output by a control circuit 918, and is output as the exponent part exp of the floating-point number being the product.

An incrementing circuit 913 increments the shift amount LSA to output the digit number DC of the mantissa part sf2 of the multiplier as in the following expression.

$$\begin{matrix} DC = LSA + 1 \\ = ( 15 - LZC 2 ) + 1 \\ = ( m - LZC 2 - 1 ) + 1 \\ = m - LZC 2\end{matrix}$$

As described above, the subtracting circuit 906 and the incrementing circuit 913 are digit number arithmetic circuits, and subtract the multiplier reading zero count value LZC2 from the digit number m of fixed precision of the mantissa part to calculate the digit number DC of the mantissa part of the multiplier.

A decrementing circuit 914 decrements an output value DC0 of a register 921 to output the value DC0−1. A selector 925 selects and outputs the digit number DC of the mantissa part sf2 of the multiplier at the time of the first multiplication for the intermediate product, and selects and outputs the output value of the decrementing circuit 914 at the time of the multiplication for the intermediate product from the second time onward. The value of the register 921 is updated to the output value of the selector 925 to be output as the value DC0 under a later-described condition.

A selector 907 selects and outputs the shift amount LSA when the carry-out co is “1”, and selects and outputs the multiplicand reading zero count value LZC1 when the carry-out co is “0” (for example, the case of FIG. 8).

A left-shifting circuit 905 left-shifts the mantissa part sf1 of the multiplicand by the output value of the selector 907 to output a mantissa part sft1 of the multiplicand.

A multiplication loop circuit (multiplying circuit) 915 receives an intermediate product r output by an r register 922, the mantissa part sft1 of the multiplicand, the mantissa part sf2 of the multiplier, and the correction signal ext to output an intermediate product A1 and the least significant digit A2 on a digit-by-digit basis of the mantissa part sf2 of the multiplier.

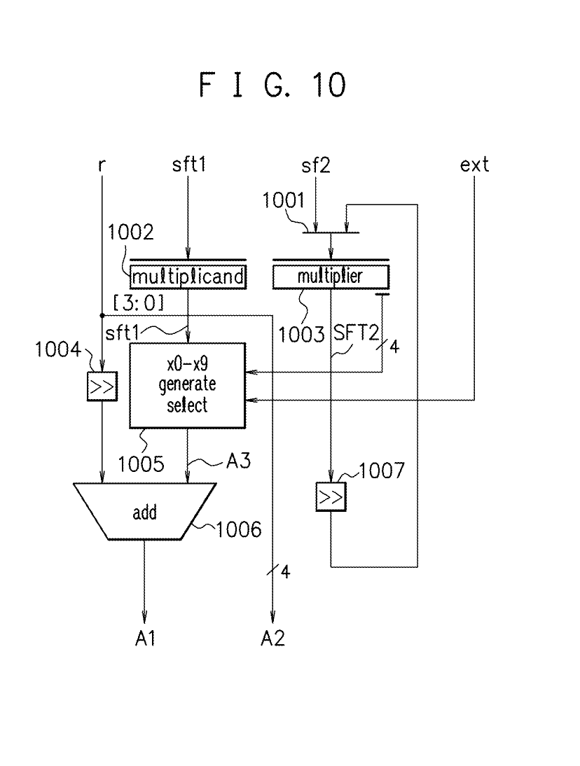

FIG. 10 is a diagram depicting a structure example of the multiplication loop circuit 915 in FIG. 9. Hereinafter, an example of the multiplication loop circuit 915 is presented, but various structures are adoptable. A selector 1001 selects and outputs the mantissa part sf2 of the multiplier at the time of the first multiplication for the intermediate product, and selects and outputs an output value of a right-shifting circuit 1007 at the time of the multiplication for the intermediate product from the second time onward. A value of a register 1003 is updated to the output value of the selector 1001 every time the multiplication for the intermediate product is performed, and is output as a mantissa part SFT2 of the multiplier. The right-shifting circuit 1007 right-shifts the mantissa part SFT2 of the multiplier by one digit to output the resultant to the selector 1001. A register 1002 stores the mantissa part sft1 of the multiplicand to output the mantissa part sft1. A product generation and select circuit 1005 generates a multiple value which is within zero times to nine times of the mantissa part sft1 of the multiplicand, and according to the least significant digit (four bits) of the mantissa part SFT2 of the multiplier stored in the register 1003 and the correction signal ext, it selects the aforesaid multiple value to output it as a partial product A3.

FIG. 11 is a chart representing a correspondence relation of an input and an output of the product generation and select circuit 1005 in FIG. 10. The input value STF2 [3:0] represents the least significant digit (four bits) of the mantissa part SFT2 of the multiplier. When the correction signal ext is “0” and when the input value STF2 [3:0] is any one of “0” to “9”, the partial product A3 is output as the multiple values which are “0” times to “9 times” of the mantissa part sft1 of the multiplicand respectively. Further, when the correction signal ext is “1”, the partial product A3 is output as “0” times of the mantissa part sft1 of the multiplicand.

In FIG. 10, the least significant digit (four bits) of the intermediate product r is output as the least significant digit A2. A right-shifting circuit 1004 right-shifts the intermediate product r by one digit to output the resultant. An adding circuit 1006 adds the output value of the right-shifting circuit 1004 and the partial product A3 to output the intermediate product A1. Here, the product generation and select circuit 1005 outputs a value whose precision is larger by one digit than the digit number m of fixed precision. The adding circuit 1006 also receives and outputs a value whose precision is larger by one digit than the digit number m of the fixed precision.

In FIG. 9, the intermediate product A1 of the multiplication loop circuit 915 is input to the r register 922. The r register 922 stores the intermediate product r whose precision is larger by one digit than the digit number m of the fixed precision and outputs the intermediate product r to the multiplication loop circuit 915 and a rounding circuit 917.

The least significant digit A2 of the multiplication loop circuit 915 is input to a g register 923. The g register 923 stores the least significant digit g and outputs the least significant digit g to the rounding circuit 917 and a logical sum (OR) circuit 916.

The logical sum circuit 916 outputs a bit logical sum value of the least significant digit (four bits) g. That is, the logical sum circuit 916 outputs “0” when the least significant digit g is “0”, and outputs “1” when the least significant digit g is any one of “1” to “9”. The output value of the logical sum circuit 916 is input to an s register 924. The s register 924 stores a sticky bit s for rounding and outputs the sticky bit s to the rounding circuit 917.

An integer part of the mantissa part of the intermediate product is stored in the r register 922. A digit in the tenths place of the mantissa part of the intermediate product is stored in the g register 923. The sticky bit in the hundredths place of the mantissa part of the intermediate product is stored in the s register 924.

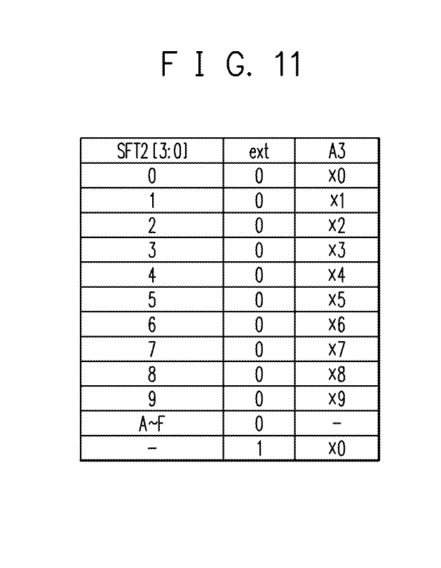

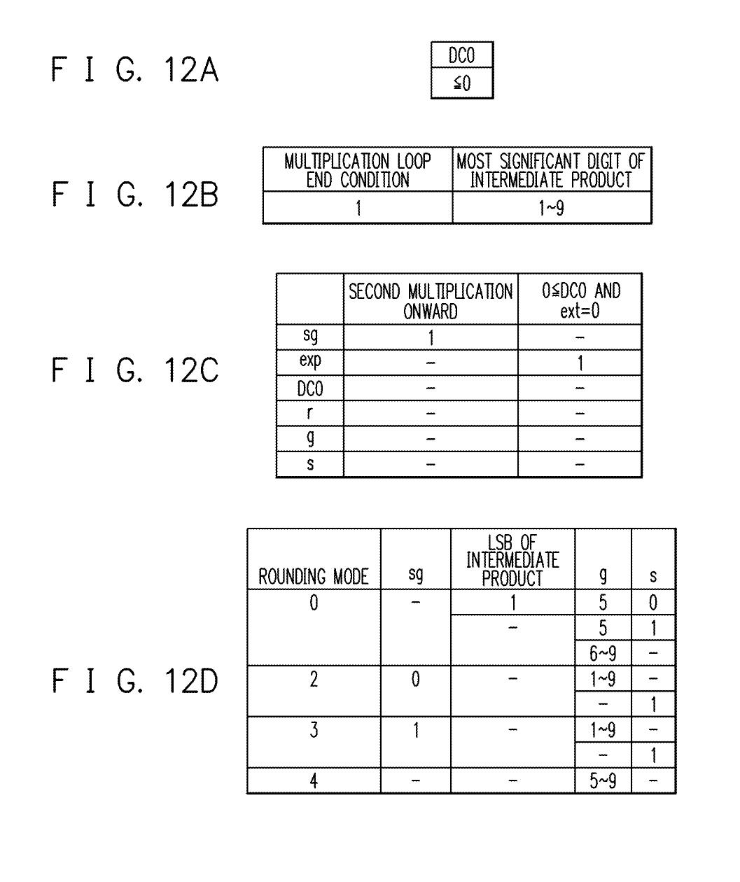

FIG. 12A to FIG. 12D are charts representing a control method of the control circuit 918 in FIG. 9. The control circuit 918 receives the output value DC0 of the register 921 and the most significant digit (m+1-th digit) of the r register 922 and outputs the correction signal ext.

FIG. 12A is a chart representing a method for the control circuit 918 to determine whether or not a multiplication loop end condition is satisfied. When the value DC0 is 0 or less, the control circuit 918 determines that the multiplication loop end condition is satisfied.

FIG. 12B is an explanatory chart of the correction signal ext output by the control circuit 918. When the multiplication loop end condition in FIG. 12A is satisfied and the most significant digit of the intermediate product r is any one of “1” to “9”, the control circuit 918 outputs the correction signal ext being “1”, and in other cases, the control circuit 918 outputs the correction signal ext being “0”. For example, in the case of FIG. 7, since the most significant digit of the seven-digit intermediate product “9890100” is “9”, the correction signal ext being “1” is output. When the correction signal ext becomes “1”, the value of the register 920 is updated to the exponent part exp+1 to which the exponent part exp is incremented and the register 922 right-shifts the intermediate product r by one digit to output the resultant as represented in FIG. 7.

FIG. 12C is a chart representing an update stop condition of the registers 919 to 924. The register 919 of the positive-negative sign sg is updated at the time of the first multiplication for the intermediate product, and at the time of the multiplication for the intermediate product from the second time onward, the update of the register 919 is stopped. The update of the register 920 of the exponent part exp is stopped when the value DC0 is zero or more and the correction signal ext is “0”. The register 921 of the value DC0, the r register 922, the g register 923, and the s register 924 are updated every time the intermediate product on a digit-by-digit basis of the mantissa part of the multiplier is calculated. The registers 919 to 924 are updated when the aforesaid update stop condition is not satisfied.

FIG. 12D is a chart representing a processing example of the rounding circuit 917. The control circuit 918 controls the rounding circuit 917 according to a rounding mode. The rounding circuit 917 receives the positive-negative sign sg of the register 919, the intermediate product r of the r register 922, the digit g in the tenths place of the g register 923, and the sticky bit s of the s register 924 and performs the rounding to output the mantissa part sf of the floating-point number being the product.

First, a case where the rounding mode is “0” will be described. In this rounding mode, the rounding circuit 917 performs rounding called bankers' rounding. When the least significant bit of the intermediate product r of the r register 922 is “1” (when the intermediate product is an odd number), and when the digit g in the tenths place of the g register 923 is “5” and the sticky bit s of the s register 924 is “0”, 1 is added to the intermediate product r relevant to the m-th least significant digit, which product is stored in the r register 922, and the resultant is output as the mantissa part sf of the product. For example, “3.5” becomes “4” by the rounding. Further, when the digit g in the tenths place of the g register 923 is “5” and the sticky bit s of the s register 924 is “1”, the rounding circuit 917 adds 1 to the intermediate product relevant to the m-th least significant digit, which product is stored in the r register 922, and outputs the resultant as the mantissa part sf of the product. For example, “2.51” becomes “3” by the rounding. Further, when the digit g in the tenths place of the g register 923 is any one of “6” to “9”, 1 is added to the intermediate product relevant to the m-th least significant digit, which product is stored in the r register 922, and the resultant is output as the mantissa part sf of the product. For example, “2.6” becomes “3” by the rounding.

Next, a case where the rounding mode is “1” will be described. In this rounding mode, the rounding circuit 917 performs rounding-down. The rounding circuit 917 outputs the intermediate product relevant to the m-th least significant digit, which product is stored in the r register 922, as it is as the mantissa part sf.

Next, a case where the rounding mode is “2” will be described. In this rounding mode, the rounding circuit 917 performs the rounding in a +∞ direction. When the positive-negative sign sg is “0” and the digit g in the tenths place of the g register 923 is any one of “1” to “9”, the rounding circuit 917 adds 1 to the intermediate product relevant to the m-th least significant digit, which product is stored in the r register 922, and outputs the resultant as the mantissa part sf of the product. Further, when the positive-negative sign sg is “0” and the sticky bit s of the s register 924 is “1”, the rounding circuit 917 adds 1 to the intermediate product relevant to the m-th least significant digit, which product is stored in the r register 922, and outputs the resultant as the mantissa part sf of the product.

Next, a case where the rounding mode is “3” will be described. In this rounding mode, the rounding circuit 917 performs the rounding in a −∞ direction. When the positive-negative sign sg is “1” and the digit g in the tenths place of the g register 923 is any one of “1” to “9”, the rounding circuit 917 adds 1 to the intermediate product relevant to the m-th least significant digit, which product is stored in the r register 922, and outputs the resultant as the mantissa part sf of the product. Further, when the positive-negative sign sg is “1” and the sticky bit s of the s register 924 is “1”, the rounding circuit 917 adds 1 to the intermediate product relevant to the m-th least significant digit, which product is stored in the r register 922, and outputs the resultant as the mantissa part sf of the product.

Next, a case where the rounding mode is “4” will be described. In this rounding mode, the rounding circuit 917 performs rounding-off. When the digit g in the tenths place of the g register 923 is any one of “5” to “9”, the rounding circuit 917 adds 1 to the intermediate product relevant to the m-th least significant digit, which product is stored in the r register 922, and outputs the resultant as the mantissa part sf of the product.

Incidentally, when the rounding is not necessary, the update of the g register 923 and the s register 924 may be skipped, and the rounding circuit 917 may output the intermediate product relevant to the m-th least significant digit, which product is stored in the r register 922, as the mantissa part sf without performing the rounding.

As a result of the above-described processing, the multiplying device outputs the product being the floating-point number including the positive-negative sign sg, the exponent part ext, and the mantissa part sf.

In the cases of FIG. 4 to FIG. 6, when the number of times the multiplication loop circuit 915 outputs the intermediate product A1 becomes the digit number DC of the mantissa part sf2 of the multiplier, the control circuit 918 outputs the intermediate product A1 output by the multiplication loop circuit 915, as the mantissa part sf of the floating-point number being the product, and outputs the value exp0 output by the adding circuit 902 as the exponent part exp of the floating-point number being the product.

Further, in the case of FIG. 7, when the number of times the multiplication loop circuit 915 outputs the intermediate product A1 becomes the digit number DC of the mantissa part sf2 of the multiplier and the digit number of the intermediate product A1 output by the multiplication loop circuit 915 exceeds the digit number m of the fixed precision of the product, the control circuit 918 outputs the value resulting from the right-shift of the intermediate product A1 output by the multiplication loop circuit 915 by one digit, as the mantissa part sf of the floating-point number being the product, and outputs the value resulting from the increment of the value exp0 output by the adding circuit 902, as the exponent part exp of the floating-point number being the product.

Further, in the case of FIG. 8, the subtracting circuit 908 and the adding circuit 909 are each an exponent part correcting circuit and add the shift amount LSA to the value exp0 output by the adding circuit 902 to output the value equal to the addition result from which the multiplicand reading zero count value LZC1 is subtracted, to the selector 910. When the shift amount LSA is larger than the multiplicand reading zero count value LZC1 (when the carry-out co is “0”), the left-shifting circuit 905 left-shifts the mantissa part sf1 of the multiplicand by the multiplicand reading zero count value LZC1. When the shift amount LSA is larger than the multiplicand reading zero count value LZC1 (when the carry-out co is “0”), the control circuit 918 outputs the value output by the adding circuit 909, as the exponent part exp of the floating-point number being the product.

Further, when the number of times the multiplication loop circuit 915 outputs the intermediate product A1 becomes the digit number DC of the mantissa part sf2 of the multiplier and the digit number of the intermediate product A1 output by the multiplication loop circuit 915 exceeds the digit number m of the fixed precision of the product, the control circuit 918 outputs the value resulting from the right-shift of the intermediate product A1 output by the multiplication loop circuit 915 by one digit, as the mantissa part sf of the floating-point number being the product, and outputs the value to which the value output by the adding circuit 909 is incremented, as the exponent part sf of the floating-point part sf of the floating-point number being the product.

Further, when the number of times the multiplication loop circuit 915 outputs the intermediate product A1 becomes the digit number DC of the mantissa part sf2 of the multiplier and the digit number of the intermediate product output by the multiplication loop circuit 915 exceeds the digit number m of the fixed precision of the product, the rounding circuit 917 rounds the intermediate product output by the multiplication loop circuit 915 and outputs the rounded intermediate product as the mantissa part sf of the floating-point number being the product.

According to this embodiment, it is possible to multiply denormalized fixed-precision floating-point numbers. Further, a highly precise product is obtained without any digit cancelation as occurring in FIG. 2. Further, the shifting circuit or the register with m×2 digits as required in FIG. 3 is not necessary, it is possible to reduce a resource amount and a delay time. Further, since algorithm for calculating the intermediate product of the multiplication loop circuit 915 may be any, an existing multiplication loop circuit 915 is usable.

### Second Embodiment

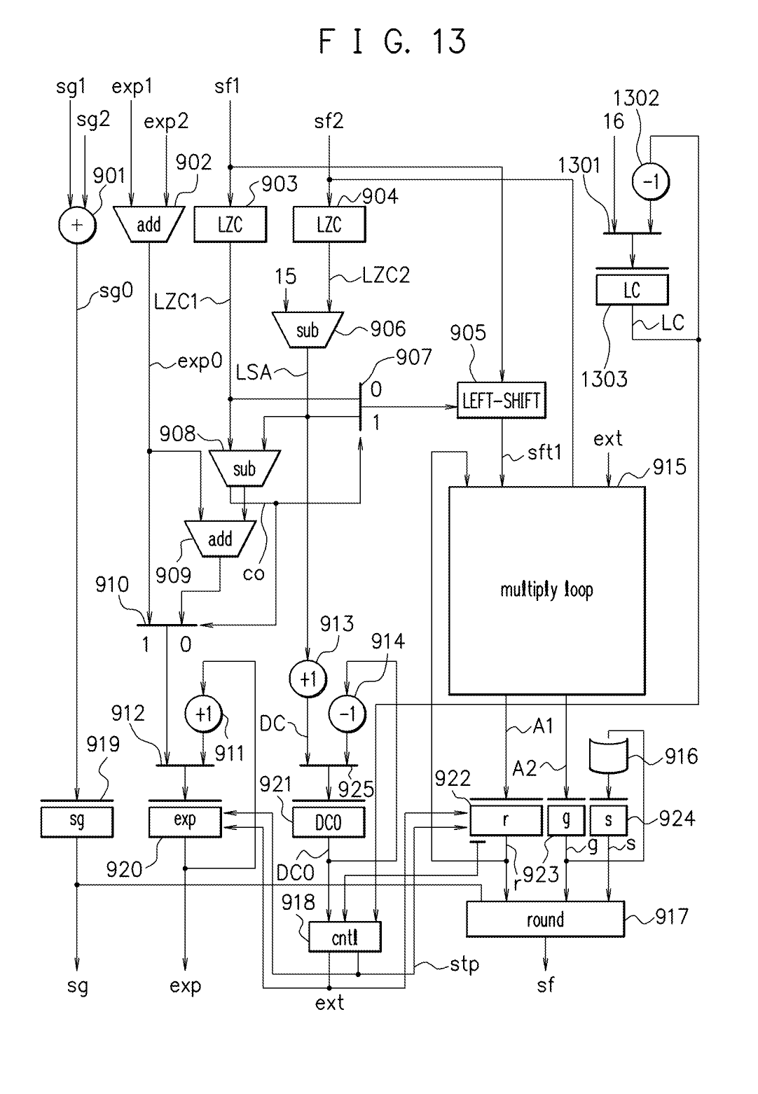

FIG. 13 is a diagram depicting a structure example of a multiplying device according to a second embodiment. The multiplying device in FIG. 13 is the multiplying device in FIG. 9 to which a selector 1301, a decrementing circuit 1302, and a register 1303 are added. Hereinafter, points where this embodiment is different from the first embodiment will be described.

This embodiment is a fixed-latency multiplying device whose input and output format is a 64-bit decimal floating-point format of IEEE754-2008. The register 1303 holds a count value LC. The decrementing circuit 1302 decrements the count value LC of the register 1303 and outputs LC−1. The digit number m (for example, “16”) of the mantissa parts sf1 and sf2 is input to the selector 1301. The digit number “16” is a count value of fixed latency. The selector 1301 selects and outputs the initial value “16” at the time of the first multiplication for the intermediate product, and selects and outputs the output value of the decrementing circuit 1302 at the time of the multiplication for the intermediate product from the second time onward. The register 1303 holds the output value of the selector 1301. The count value LC of the register 1303 is output to the control circuit 918. The control circuit 918 receives the output value DC0 of the register 921, the most significant digit of the r register 922, and the count value LC of the register 1303 and outputs the correction signal ext and a register update stop signal stp.

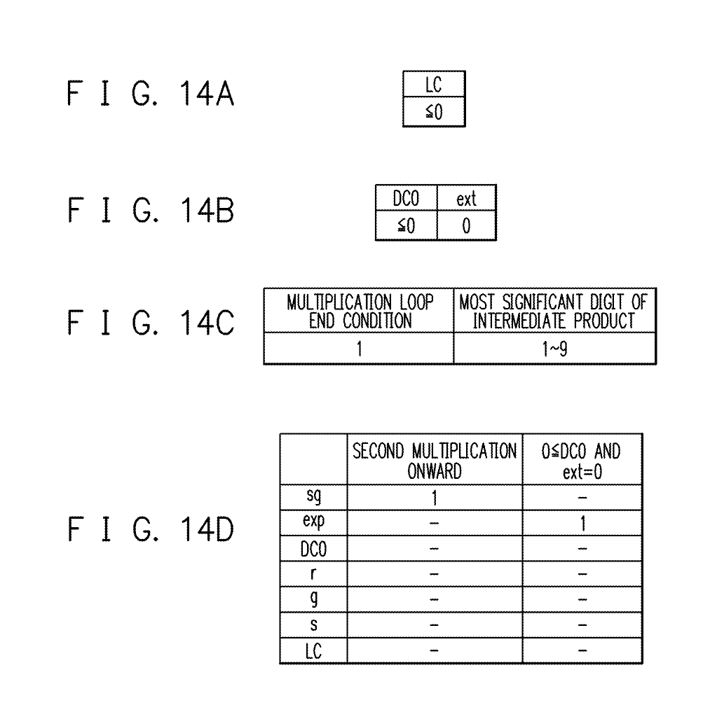

FIG. 14A to FIG. 14D are charts representing a control method of the control circuit 918 in FIG. 13. FIG. 14A is a chart representing a method for the control circuit 918 to determine whether or not a multiplication loop end condition is satisfied. When the count value LC of the register 1303 is 0 or less, the control circuit 918 determines that the multiplication loop end condition is satisfied.

FIG. 14B is an explanatory chart of the register update stop signal stp output by the control circuit 918. When the value DC0 is 0 or less and the correction signal ext is “0”, the control circuit 918 outputs the register update stop signal stp being “1”. When the register update stop signal stp becomes “1”, the update of the values of the registers 920 and 922 is stopped.

FIG. 14C is an explanatory chart of the correction signal ext output by the control circuit 918. When the multiplication loop end condition in FIG. 14A is satisfied and the most significant digit of the r register 922 is any one of “1” to “9” (the case of FIG. 7), the control circuit 918 outputs the correction signal ext being “1”, and in other cases, the control circuit 918 outputs the correction signal ext being “0”.

FIG. 14D is a chart representing an update stop condition of the registers 919 to 924, 1303. The update stop condition of the registers 919 to 924 is the same as the update stop condition in FIG. 12C. The register 1303 of the count value LC is updated every time the intermediate product on a digit-by-digit basis of the mantissa part of the multiplier is calculated.

As described above, after the count value LC (initial value is “16”) of the fixed latency is counted, the control circuit 918 outputs the positive-negative sign sg, the mantissa part sf, and the exponent part exp of the floating-point number being the product. In the multiplying device of the first embodiment, the time from the input of the multiplicand and the multiplier to the output of the product is variable latency which is variable according to the multiplicand and the multiplier. On the other hand, in the multiplying device of this embodiment, latency is fixed latency, that is, the time from the input of the multiplicand and the multiplier to the output of the product is fixed irrespective of the multiplicand and the multiplier. This facilitates processing of circuits on subsequent stages of the multiplying device.

In the first and second embodiments, the case of a decimal number is described as an example, but it should be noted that the decimal number is not restrictive.

The above-described embodiments only illustrate concrete examples for carrying out the present invention, and the technical scope of the present invention should not be construed in a limited manner by these embodiments. That is, the present invention can be embodied in various forms without departing from its technical idea or its main features.

It is possible to multiply floating-point numbers with a small resource amount and delay time.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multiplying device comprising:
a counting circuit which counts the number of zeros consecutive in higher places of a mantissa part of a floating-point number being a multiplier;
a shift amount arithmetic circuit which calculates a shift amount based on a digit number of fixed precision of the mantissa part and a count value counted by the counting circuit;
a shifting circuit which left-shifts a mantissa part of a floating-point number being a multiplicand by the shift amount;
a digit number arithmetic circuit which calculates a digit number of the mantissa part of the multiplier by subtracting the count value from the digit number of the fixed precision of the mantissa part;
a multiplying circuit which outputs an intermediate product on a digit-by-digit basis of the mantissa part of the multiplier based on the mantissa part of the multiplicand left-shifted by the shifting circuit and the mantissa part of the multiplier;
an adding circuit which adds an exponent part of the floating-point number being the multiplicand and an exponent part of the floating-point number being the multiplier to output an addition value; and
a control circuit which outputs the intermediate product output by the multiplying circuit as a mantissa part of a floating-point number being a product and outputs the value output by the adding circuit as an exponent part of the floating-point number being the product, when the number of times the multiplying circuit outputs the intermediate product is the digit number calculated by the digit number arithmetic circuit.

2. The multiplying device according to claim 1,
wherein, when the number of times the multiplying circuit outputs the intermediate product becomes the digit number calculated by the digit number arithmetic circuit and a digit number of the intermediate product output by the multiplying circuit exceeds a digit number of fixed precision of the product, the control circuit outputs a value resulting from right-shift of the intermediate product output by the multiplying circuit by one digit, as the mantissa part of the floating-point number being the product and outputs a value to which the value output by the adding circuit is incremented, as the exponent part of the floating-point number being the product.

3. The multiplying device according to claim 1, further comprising:
a second counting circuit which counts the number of zeros consecutive in higher places of the mantissa part of the multiplicand;
an exponent part correcting circuit which adds the shift amount to the value output by the adding circuit and subtracts a second count value counted by the second counting circuit from an addition value to output a resultant value,
wherein, when the shift amount calculated by the shift amount arithmetic circuit is larger than the second count value, the shifting circuit left-shifts the mantissa part of the multiplicand by the second count value, and
wherein, when the shift amount calculated by the shift amount arithmetic circuit is larger than the second count value, the control circuit outputs the value output by the exponent part correcting circuit, as the exponent part of the floating-point number being the product.

4. The multiplying device according to claim 3,
wherein, when the number of times the multiplying circuit outputs the intermediate product becomes the digit number calculated by the digit number arithmetic circuit and the digit number of the intermediate product output by the multiplying circuit exceeds a digit number of fixed precision of the product, the control circuit outputs a value resulting from right-shift of the intermediate product output by the multiplying circuit by one digit, as the mantissa part of the floating-point number being the product, and outputs a value to which the value output by the exponent part correcting circuit is incremented, as the exponent part of the floating-point number being the product.

5. The multiplying device according to claim 1, further comprising a rounding circuit which, when the number of times the multiplying circuit outputs the intermediate product becomes the digit number calculated by the digit number arithmetic circuit and the digit number of the intermediate product output by the multiplying circuit exceeds a digit number of fixed precision of the product, rounds the intermediate product output by the multiplying circuit, and outputs the rounded intermediate product as the mantissa part of the floating-point number being the product.

6. The multiplying device according to claim 1, further comprising a positive-negative sign arithmetic circuit which, when an input positive-negative sign of the floating-point number being the multiplicand and an input positive-negative sign of the floating-point number being the multiplier are the same, outputs a positive-negative sign of the floating-point number being the product as positive, and when the input positive-negative sign of the floating-point number being the multiplicand and the input positive-negative sign of the floating-point number being the multiplier are different, outputs the positive-negative sign of the floating-point number being the product as negative.

7. The multiplying device according to claim 1,
wherein the shift amount arithmetic circuit calculates the shift amount by subtracting the count value and 1 from a digit number of the fixed precision of the mantissa part.

8. The multiplying device according to claim 1,
wherein the control circuit outputs the mantissa part and the exponent part of the floating-point number being the product after counting a count value of fixed latency.

9. A multiplying method comprising:
counting, by a counting circuit, the number of zeros consecutive in higher places of a mantissa part of a floating-point number being a multiplier, as a count value;
calculating, by a shift amount arithmetic circuit, a shift amount based on a digit number of fixed precision of the mantissa part and the count value;
left-shifting, by a shifting circuit, a mantissa part of a floating-point number being a multiplicand by the shift amount;
calculating, by a digit number arithmetic circuit,
a digit number of the mantissa part of the multiplier by subtracting the count value from the digit number of the fixed precision of the mantissa part;
outputting, by a multiplying circuit, an intermediate product on a digit-by-digit basis of the mantissa part of the multiplier based on the mantissa part of the multiplicand left-shifted by the shifting circuit and the mantissa part of the multiplier;
adding, by an adding circuit, an exponent part of the floating-point number being the multiplicand and an exponent part of the floating-point number being the multiplier to output an addition value; and
outputting, by a control circuit, the intermediate product output by the multiplying circuit, as a mantissa part of a floating-point number being a product and outputting the value output by the adding circuit, as an exponent part of the floating-point number being the product when the number of times the multiplying circuit outputs the intermediate product becomes the digit number calculated by the digit number arithmetic circuit.
